(19) United States
(12) Patent Application Publication
(10) Pub. No.: US 2012/0210354 A1
(43) Pub. Date: Aug. 16, 2012

(54) GRAPHICAL NATIVE USER INTERFACE AND CONTROL FOR DEVICES WITHOUT GRAPHICAL USER INTERFACE

(75) Inventors: Ling Jun Wong, Escondido, CA (US); Charles McCoy, Coronado, CA (US); True Xiong, San Diego, CA (US)

(73) Assignees: Sony Network Entertainment International LLC, Los Angeles, CA (US); Sony Corporation, Tokyo (JP)

(21) Appl. No.: 13/073,795

(22) Filed: Mar. 28, 2011

Related U.S. Application Data
(60) Provisional application No. 61/442,156, filed on Feb. 11, 2011.

(51) Int. Cl. H04N 5/445

(52) U.S. Cl. 725/38

(57) ABSTRACT

Managing settings for a first network-connected device using a second device, including: accessing the first network-connected device configured as an IPTV client from the second device, wherein the IPTV client is configured without a GUI and the second device is configured with a GUI; retrieving current settings of the IPTV client; modifying and/or controlling settings of the IPTV client using a display of the second device; and communicating the modifications and/or controls of the settings to the IPTV client. Keywords include setting controls and network-connected device.

### CROSS-REFERENCE TO RELATED APPLICATIONS

This application claims the benefit of priority of co-pending U.S. Provisional Patent Application No. 61/442,156, filed Feb. 11, 2011, entitled “Graphical. Native User Interface and Control for Devices without a Graphical User Interface.” The disclosure of the above-referenced patent application is incorporated herein by reference.

### BACKGROUND

1. Field of the Invention

The present invention relates to IPTV devices, and more specifically, to graphical native user interface and control.

2. Background

Internet video services such as Bravia Internet Video Link (BIVL) enable users to browse and search content on the Internet. The browsing and searching can be done using Internet Protocol television (IPTV) which uses the architecture and networking methods of the Internet Protocol Suite over a packet-switched network infrastructure.

The popularity of the IPTV can be increased by providing a solution to the difficulty of navigating around (e.g., browsing and searching BIVL content) a main display without disturbing the viewing experience of other users who are watching the main display. However, there are issues of cumbersome data entry, limitations in memory and processing power, and difficulties in effective content searches.

### SUMMARY

The present invention provides for managing settings for a first network-connected device using a second device.

In one implementation, a method of managing settings for a first network-connected device using a second device is disclosed. The method includes: accessing the first network-connected device configured as an IPTV client from the second device, wherein the IPTV client is configured without a GUI and the second device is configured with a GUI; retrieving current settings of the IPTV client; modifying and/or controlling settings of the IPTV client using a display of the second device; and communicating the modifications and/or controls of the settings to the IPTV client.

In another implementation, a non-transitory storage medium storing a computer program to manage settings for a first network-connected device using a second device is disclosed. The computer program includes executable instructions that cause a computer to: access the first network-connected device configured as an IPTV client from the second device, wherein the IPTV client is configured without a GUI and the second device is configured with a GUI; retrieve current settings of the IPTV client; modify and/or control settings of the IPTV client using a display of the second device; and communicate the modifications and/or controls of the settings to the IPTV client.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a flowchart illustrating a process for reconfiguring a system so that the second device with a GUI is used to view the settings of the first network-connected device and control the settings from the second device in accordance with one implementation of the present invention.

FIG. 2 shows a system configured to enable a user browsing media content on a second device to have the selection played by a first device.

FIG. 3A illustrates a representation of a computer system and a user.

FIG. 3B is a functional block diagram illustrating the computer system hosting a setting manager.

### DETAILED DESCRIPTION

Certain implementations as disclosed herein provide for allowing a user of a first device (e.g., a network-connected device such as an IPTV client) without a graphical user interface (GUI) to view and control the settings of the network-connected device by using a display on a second device. After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention.

In one implementation, a second device is used to browse, search, and select media content (e.g., BIVL content) but the selected media content is played on a first device (e.g., a big screen IPTV for convenient viewing). The user can then continue to browse the media content on any number of additional devices without interrupting the content that is being played on the first device. By requiring that the user send the selected media content for playback on the IPTV client only when the user is ready to watch the content, the security risks can be substantially reduced because the playback of proprietary media content occurs only on the authenticated IPTV client rather than on a non-authenticated second device. Since the web application of the second device is usually written in HTML, it can be loaded by any device with a browser. It should be noted that the web application need not necessarily be written in HTML but in any browser-supported language such as Java Script and/or other markup languages. Further, in an alternative, the user can use a native application already installed on the second device rather than loading the web application. The second device can be any device that is within a same local network as the first device, and can include cellular phones, laptop computers, and other portable devices, which are already owned by most users.

As discussed above, a network-connected device such as an IPTV client can be configured without a graphical user interface (GUI). For example, a network-connected device configured as a home audio device may have only a textual user interface with no keyboard input or graphics. In this case, in which a network-connected device is configured without a GUI, the IPTV server can reconfigure the system so that the owner of the network connected device can view the settings of the device and control the settings from the second device. The device settings such as volume control, surround sound settings, presets, tuner search command, or proxy/network settings can be viewed and controlled over a network using the second device. Thus, this configuration provides an easy way to control devices with limited user interface.

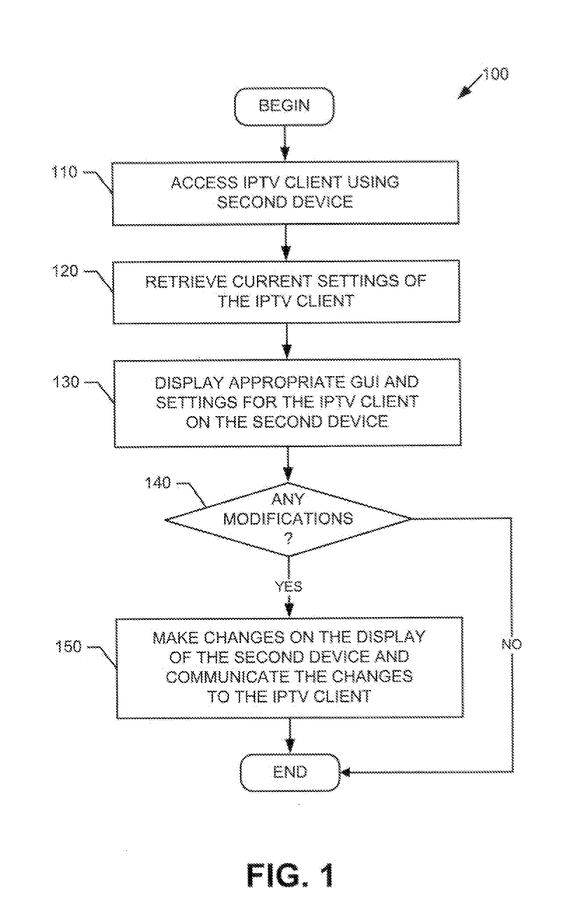

FIG. 1 is a flowchart illustrating a process 100 for reconfiguring a system so that the second device with a GUI is used to view the settings of the first network-connected device (e.g., an IPTV client without a GUI) and control the settings from the second device in accordance with one implementation of the present invention. In the illustrated implementation of FIG. 1, the second device accesses the IPTV client, at box 110, and retrieves the current settings of the IPTV client, at box 120. The display on the second device shows the appropriate GUI for the IPTV client together with the right settings, at box 130. If it is determined, at box 140, that modifications are needed, the user makes any modifications on the display of the second device, at box 150, including adding or deleting to the settings, and communicates the modifications to the IPTV client. In one example, modifications are made to volume control or other native settings of the IPTV client such as activating or setting tuner preset or performing a tuner search command.

In one implementation, the second device provides a graphical control for the native settings of the first device such as IPTV client which may or may not have the Internet media content service capability (e.g., BIVL). When a user desires to search and browse media content on the Internet, the user uses the second device to establish some form of authentication so that the second device has the credentials to search and browse on behalf of the IPTV client. Toward that goal, the second device can obtain a list of appropriate devices (e.g., BIVL devices) from an IPTV server. However, if the IPTV client'configured without a GUI (e.g., a home audio device) does not support searching and browsing media content, then the second device would be used to control the native settings of the IPTV client. Hence, in this case, discovering the home audio device through a discovery protocol (rather than logging onto the server) will suffice in establishing a communication channel between the first home audio device and the second device which are in the same local network.

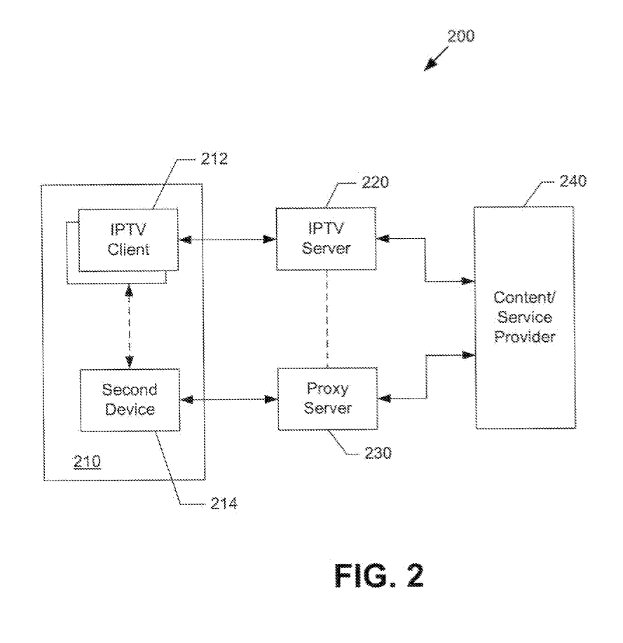

FIG. 2 shows a system 200 configured to enable a user browsing media content on a second device to have the selection played by a first device. The system 200 can also be reconfigured so that the second device with a GUI is used to view the settings of the first device (without a GUI) and control the settings from the second device. In the illustrated implementation of FIG. 2, the system 200 includes an IPTV client 212 and a second device 214 configured within a same local network 210, which are in communication with an IPTV server 220 and a proxy server 230. The servers 220, 230 are in communication with a content/service provider 240.

In one implementation, the IPTV server 220 reconfigures the system 200 so that the second device 214 with a GUI (e.g., a laptop computer) is used to view the settings of the IPTV client 212 and control the settings from the second device 214. In one example, the settings which can be controlled from the second device 214 include the volume control, surround sound settings, presets, or even proxy or network settings. However, it should be noted that any settings or configurations on the device can be controlled by the second device 214.

In this implementation, the user loads a web application in the second device 214 and logs into an account in the proxy server 230 configured to provide media content service. In an alternative implementation, the user can use a native application already installed on the second device to log into the proxy server account. Once logged into the account, the second device 214 receives a list of compatible IPTV clients 212.

In the case of a non-BIVL IPTV client, a local discovery protocol can also be made to discover the IPTV device instead of logging onto the server. In this case, the second device controls only the native settings of the IPTV device (no BIVL aspect in case), and there is also no communication with any entity outside the local network.

Using the second device, the user selects an IPTV client 212. A list of services available to the client 212 is shown on the display of the second device 214. The user can browse and search services and contents in the preferred language of the user. For security reasons, content transaction between the second device 214 and the content/service provider 240 occurs on the proxy server 230 to create a firewall. When content is selected by the user using the second device 214, the content will be sent to the IPTV client 212 for playback. However, the second device 214 sends only a reference identifier for the selected content to the IPTV client 212, which retrieves the content using the reference identifier.

The authenticated IPTV client 212 sends the reference identifier to the IPTV server 220 which in turn sends it to the content/service provider 240. The IPTV client 212 receives the content selected by the second device 214 from the content/service provider 240 through the IPTV server 220. Thus, the unauthenticated second device 214 is not given access to the content URL to reduce the risk of exposing proprietary information. During playback, the user using the second device 214 continues to browse, search, select, and queue other content for future playback without interrupting the content that is being played on the IPTV client 212. In one implementation, both the selected IPTV client 212 and the second device 214 must be in the same local network 210 in order to perform a playback of the selected content. The user can also switch clients 212 and resume playback on a different client by selecting from a recently viewed list of the last media content played and after switching control to that device. In another implementation, the communication between the two devices can be passed through a server in the cloud which maintains a communication channel with both devices.

In a further implementation, the second device 214 accesses the IPTV client 212 and retrieves the current settings of the IPTV client 212. The display on the second device 214 shows the appropriate GUI and settings for the IPTV client 212. The second device 214 is used to make any modifications including adding or deleting to the settings. The modifications are communicated to the IPTV client 212.

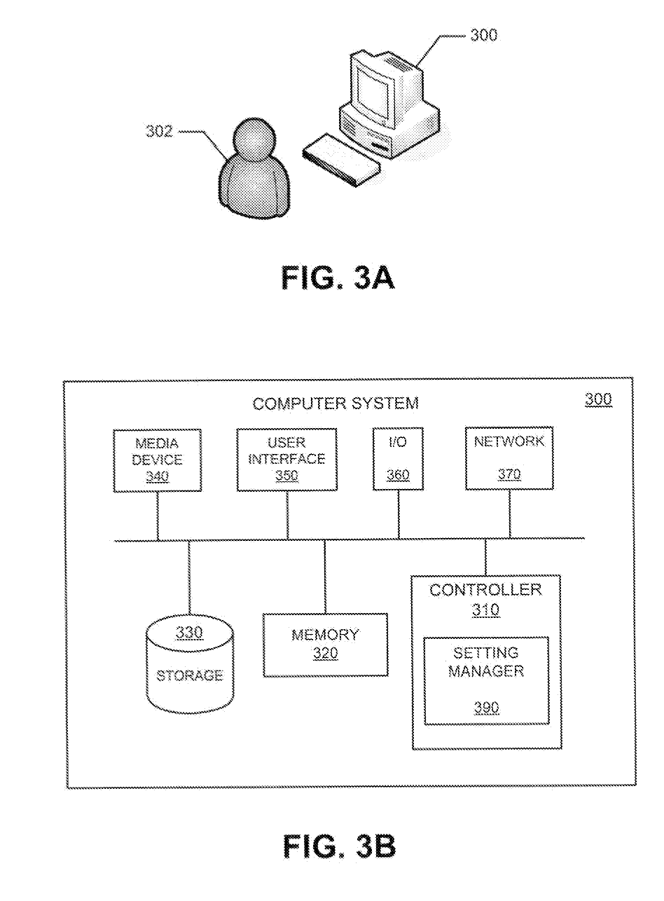

FIG. 3A illustrates a representation of a computer system 300 and a user 302. The user 302 uses the computer system 300 having a GUI to view, modify, and control settings of a network-connected device. The computer system 300 stores and executes a setting manager 390.

FIG. 3B is a functional block diagram illustrating the computer system 300 hosting the setting manager 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the setting manager 390 as a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data temporarily or long term for use by other components of the computer system 300, such as for storing data used by the setting manager 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user. In one implementation, the user interface 350 includes a keyboard, a mouse, audio speakers, and a display. The controller 310 uses input from the user to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, the settings of the network-connected device can be saved to a file through the second device interface or stored on the server. This would enable the settings to be reapplied to the same network-connected device, or even another network-connected device of a compatible model, by reloading the settings from the file. This could be further extended to enable files with partial settings to be created and modified through the second device. This would, for example, allow a user to create a file with channel and volume settings that could then be applied to several network-connected devices (e.g., an IPTV client) without modifying any of the other settings on those network-connected devices. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of managing settings for a first network-connected device using a second device, the method comprising;
accessing the first network-connected device configured as an IPTV client from the second device,
wherein the IPTV client is configured without a GUI and the second device is configured with a GUI;
retrieving current settings of the IPTV client;
modifying and/or controlling settings of the IPTV client using a display of the second device; and
communicating the modifications and/or controls of the settings to the IPTV client.

2. The method of claim 1, further comprising
displaying appropriate GUI and settings for the IPTV client on the display of the second device.

3. The method of claim 1, wherein the second device comprises
one of cellphone, laptop, and other portable device.

4. The method of claim 1, wherein modifying and/or controlling settings of the IPTV client comprises
modifying and/or controlling native settings of the IPTV client including volume settings.

5. The method of claim 1, wherein modifying and/or controlling settings of the IPTV client comprises
activating or setting tuner preset.

6. The method of claim 1, further comprising
browsing, searching, and selecting network media content using the second device on behalf of the IPTV client.

7. The method of claim 6, further comprising
sending the selected media content to the IPTV client for playback.

8. The method of claim 7, wherein sending the selected media content to the IPTV client comprises
sending only a reference identifier for the selected media content to the IPTV client.

9. The method of claim 8, further comprising
retrieving and downloading the selected media content by the IPTV client using the reference identifier,
wherein access to the selected media content by the second device is only through the reference identifier.

10. The method of claim 1, wherein the IPTV client and the second device are configured as residing within one local network.

11. The method of claim 1, further comprising
enabling the second device to load a web application, and to log into an account in a proxy server.

12. The method of claim 11, further comprising
sending a list of compatible IPTV clients from the proxy server.

13. The method of claim 12, further comprising
enabling the second device to select an IPTV client from the list of compatible IPTV clients.

14. A non-transitory storage medium storing a computer program to manage settings for a first network-connected device using a second device, the computer program comprising executable instructions that cause a computer to:
access the first network-connected device configured as an IPTV client from the second device,
wherein the IPTV client is configured without a GUI and the second device is configured with a GUI;
retrieve current settings of the IPTV client;
modify and/or control settings of the IPTV client using a display of the second device; and
communicate the modifications and/or controls of the settings to the IPTV client.

15. The non-transitory storage medium of claim 14, further comprising executable instructions that cause a computer to:
display appropriate GUI and settings for the IPTV client on the display of the second device.

16. The non-transitory storage medium of claim 14, wherein executable instructions that cause a computer to modify and/or control settings of the IPTV client comprise executable instructions that cause a computer to:
modify and/or control native settings of the IPTV client including volume settings.

17. The non-transitory storage medium of claim 14, wherein executable instructions that cause a computer to modify and/or control settings of the IPTV client comprise executable instructions that cause a computer to:
activate or set tuner preset.

18. The non-transitory storage medium of claim 14, further comprising executable instruction that cause computer to:
browse, search, and select network media content using the second device on behalf of the IPTV client.

19. The non-transitory storage medium of claim 14, further comprising executable instructions that cause a computer to:
enable the second device to load a web application, and to log into an account in a proxy server.

20. The non-transitory storage medium of claim 19, further comprising executable instructions that cause a computer to:
sending a list of compatible IPTV clients from the proxy server.
